(19) United States
(12) Patent Application Publication
(10) Pub. No.: US 2026/0087545 A1
(43) Pub. Date: Mar. 26, 2026

(54) ARTIFICIAL INTELLIGENCE BASED AUCTION BIDDING SYSTEM AND METHOD THEREOF

(71) Applicant: Nouriel Yazdinian, Beverly Hills, CA (US)

(72) Inventor: Nouriel Yazdinian, Beverly Hills, CA (US)

(21) Appl. No.: 18/891,552

(22) Filed: Sep. 20, 2024

(51) Int. Cl. G06Q 30/08; G06Q 30/0601; G10L 15/26; H04M 3/22

(52) U.S. Cl. CPC G06Q 30/08; G06Q 30/0619; H04M 3/2209; G10L 15/26

(57) ABSTRACT

Disclosed is a system for AI-based auction bidding and a method thereof. The method includes receiving a sign-up request for an auction. The method includes initiating, by an AI bidding bot, a phone call to a mobile device of the client before the initiating the auction process. The method also includes presenting a disclaimer to the client specifying bid finality, bidding currency, urgency of bidding, and liability limitations. The method further includes presenting bid amounts to the client and requesting confirmation of the bid amounts. The method also includes receiving the bid confirmation from a client as a voice prompts. The method includes sending the voice prompt to an NLP engine and converting voice prompt to text data. The method further includes updating, by the AI bidding bot, the database with the confirmed bid. The method also includes automatically transmitting the confirmed bid to a central site via Webhook.

### FIELD OF THE INVENTION

The present invention relates to auction bidding system and more particularly relates to an artificial intelligence based auction bidding system and a method thereof.

### BACKGROUND OF THE INVENTION

Auction bidding systems have evolved significantly over the past few decades, transitioning from in-person events to telephone bidding and eventually to online platforms. However, existing solutions still face numerous challenges and limitations.

Current remote bidding systems often rely on human operators to manage telephone bids, which introduce several disadvantages. Human-operated systems can only handle a finite number of bidders simultaneously, which restrict auction house capacity and potential revenue. These systems are typically limited to one or a few languages while also hindering international participation. Manual bid placement is susceptible to misunderstandings, delays, or mistakes, potentially resulting in lost bids or disputes. Moreover, human operators may not be available 24/7, limiting the auction house's ability to cater to different time zones or conduct impromptu auctions.

Online bidding platforms have addressed some of these issues, however, these platforms face new challenges. Many potential bidders, especially older demographics or those in regions with limited internet access, may struggle with purely online systems. These platforms often fail to fulfill personal engagement of traditional auctions. Online-only systems are vulnerable to various cyber threats, including hacking and fraud.

Existing automated systems, while an improvement, still have drawbacks. Most automated systems have basic language processing capabilities often restricted to simple commands in a single language. Many lack the ability to adapt to unexpected situations or unique bidder requests. Current systems often lack robust backup measures for situations like dropped calls or system failures. Additionally, many automated systems operate in isolation, thus failing to integrate seamlessly with various auction platforms and backend systems.

Hence, there is a need for an invention that addresses these limitations by providing a multi-lingual AI-based phone bidding system that combines the phone bidding with the efficiency of automation.

### BRIEF SUMMARY OF THE INVENTION

It is an object of the present invention to provide a multi-lingual AI-based phone bidding system that combines the phone bidding with automation efficiency.

It is another object of the present invention to provide natural language processing capabilities in multiple languages while enabling global auction participation.

It is a further object of the present invention to implement an adaptive calling system that considers time zones, client preferences, and auction priorities.

It is another object of the present invention to ensure continuous bidding through failsafe mechanisms, including absentee bidding protocols and backup communication channels.

It is a further object of the present invention to provide a system that adapts to unexpected situations and unique bidder requests while providing flexibility beyond traditional automated systems.

According to an embodiment, a method for automated auction bidding is disclosed. The method is implemented using an AI-based auction bidding system. The method includes receiving, from a client, a sign-up request for an auction. The method also includes upon approval of the sign-up request, receiving auction and lot details from the client. The method further includes storing the received details in a database. The method also includes initiating, by an AI bidding bot, a phone call to a mobile device of the client at a predetermined time before the initiating the auction process and simultaneously sending a text reminder to the client. The method includes presenting, by the AI bidding bot, a disclaimer to the client specifying bid finality, bidding currency, urgency of bidding, and liability limitations. The method also includes receiving, from the client, a preferred bidding language selection from a group consisting of Arabic, Japanese, Chinese Mandarin, Russian, German, French, and Spanish. The method further includes presenting, by the AI bidding bot, bid amounts to the client and requesting confirmation of the bid amounts. The method also includes receiving, by the AI bidding bot, the bid confirmation from a client as a voice prompt, the voice prompt being the client preferred language. The method further includes sending the voice prompt to a natural language processing (NLP) engine and converting voice prompt to text data. The method includes updating, by the AI bidding bot, the database with the confirmed bid. The method also includes automatically transmitting the confirmed bid to a central site via Webhook.

According to an embodiment, a system for automated auction bidding is disclosed. The method includes receiving, from a client, a sign-up request for an auction. The method also includes upon approval of the sign-up request, receiving auction and lot details from the client. The method further includes storing the received details in a database. The method also includes initiating, by an AI bidding bot, a phone call to a mobile device of the client at a predetermined time before the initiating the auction process and simultaneously sending a text reminder to the client. The method includes presenting, by the AI bidding bot, a disclaimer to the client specifying bid finality, bidding currency, urgency of bidding, and liability limitations. The method also includes receiving, from the client, a preferred bidding language selection from a group consisting of Arabic, Japanese, Chinese Mandarin, Russian, German, French, and Spanish. The method further includes presenting, by the AI bidding bot, bid amounts to the client and requesting confirmation of the bid amounts. The method also includes receiving, by the AI bidding bot, the bid confirmation from a client as a voice prompt, the voice prompt being the client preferred language. The method further includes sending the voice prompt to a natural language processing (NLP) engine and converting voice prompt to text data. The method includes updating, by the AI bidding bot, the database with the confirmed bid. The method also includes automatically transmitting the confirmed bid to a central site via Webhook.

### BRIEF DESCRIPTION OF DRAWINGS

The present invention will become clearly understood to those of ordinary skill in the art when descriptions of exemplary embodiments thereof are read with reference to the accompanying drawings.

FIG. 1 is a schematic view of the key components of a system for automated auction bidding.

FIG. 2 is a block flow diagram of a system for automated auction bidding according to an embodiment of the present invention.

FIG. 3 is a flowchart illustrating the method of automated auction bidding according to an embodiment of the present invention.

FIG. 4 is a block diagram of a computing device used for implementing the system of FIG. 2.

FIG. 5 is a schematic view of a process of transferring the bids to a central auction site.

### DETAILED DESCRIPTION OF THE INVENTION

The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention. For a more complete understanding of the present invention, reference is now made to the following descriptions taken in conjunction with the accompanying drawings.

The present invention aims to address limitations of existing systems by providing a multi-lingual AI bidding system that combines the phone bidding with the automation efficiency. It provides language processing capabilities, adaptive calling systems, failsafe mechanisms, and seamless integration with existing auction infrastructures.

Further, this invention utilizes natural language processing (NLP), communicatively coupled with a plurality of communication channels (voice, text, email) to provide unparalleled accessibility and user experience. The ability to place absentee bids and adapt to connection issues ensures that bidders never miss an opportunity due to technical difficulties.

The present invention is scalable through its use of cloud computing and microservices architecture, which allows auction houses to handle a virtually unlimited number of simultaneous bidders across different auctions and time zones.

The term “artificial intelligence” or AI used in this disclosure typically refers to “machine intelligence” that includes a computer model, algorithm or simulation of human intelligence processes by machines, such as computer systems to learn, predict, analyze and provide actionable insight, and/or control actuators. The AI may be a machine learning algorithm, wherein the machine learning algorithm may include a trained machine learning algorithm. Typically, the machine learning algorithm may be trained using supervised, semi-supervised, unsupervised or reinforcement learning techniques which includes neural networks and support vector machines.

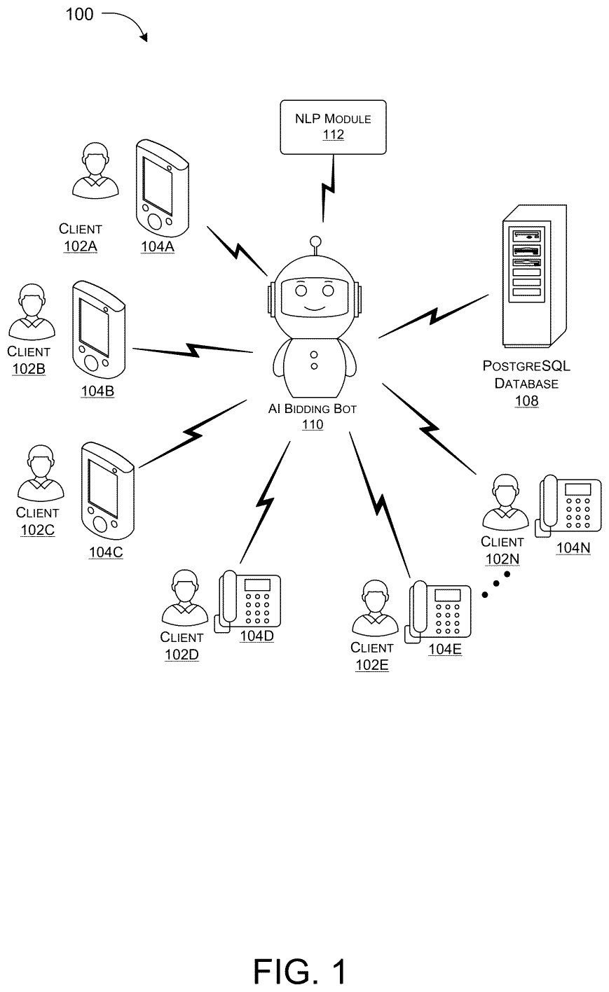

According to an embodiment of the present invention, a system 100 for automated auction bidding is disclosed as shown in FIG. 1. The system 100 is implemented using an electronic device such as a mobile communication device, which includes but not limited to a laptop computer, a mobile station, a desktop computer, a portable electronic device such as a mobile device, a PDA, a subscriber station, a tablet computer, a wireless terminal, a wearable device, and the like. The core components of the system 100 are an artificial intelligence (AI) bidding bot module 110, a natural language processing (NLP) module 112, and a database 108. In various aspects, the AI bidding bot module 110 communicates with one or more user devices 104A-104N of one or more clients 102A-102N, via a communication network. The communication network includes at least one of broadband network and a narrowband network. The broadband network includes a public mobile communication network including but not limited to at least one of 3G, 4G and 5G networks and/or a wireless local area network including but not limited to WiFi network. The narrowband network includes but not limited to at least one of NB-IoT (Narrow Band Internet of Things) network, LTE-M (LTE-Machine to Machine) network, and Long Range Radio (Long Range Radio) network.

In various aspects of the present invention, the term “client” is also referred to as auction participant.

The artificial intelligence (AI) bidding bot module 110 functions in association with the NLP module 112 to identify the voice prompts input by the clients. The user devices 104A-104N include but not limited to a mobile device, a telephone, a smart device and the like. In some aspects, the user may use a mobile auction application, in their user devices 104A-104N, that the client utilize to view the auction updates in real-time. The auction details are updated in the database 108. An event communication module monitors the database 108 for updated auction data and continuously communicates the updated auction data automatically to a central auction site. The clients monitor the auction data via the central auction site in real-time. In an embodiment, the event communication module includes Webhook that updates the central auction site when an event is triggered. The event includes confirmation or rejection of bids by the client that is updated in the database 108. In an exemplary aspect, the database 108 includes PostgreSQL database.

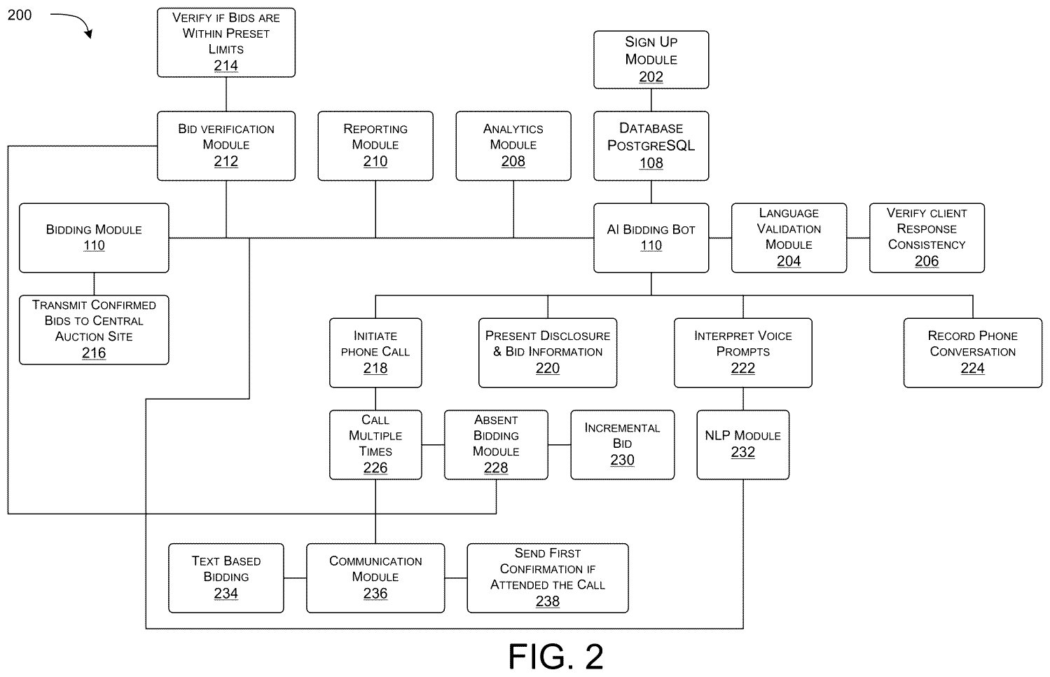

According to an exemplary embodiment of the present invention, a system 200 for artificial intelligence (AI) based auction bidding is disclosed. A simplified block flow diagram of the same is depicted in FIG. 2. The system includes a plurality of modules such as a sign-up module 202, a relational database management system (RDBMS) 108, an artificial intelligence (AI) bidding bot module 110, a natural language processing (NLP) engine 232, a communication module 236, an absentee bidding module 228, a language validation module 204, a bid verification module 212, an analytical module 208 and a reporting module 210.

In an exemplary embodiment of the present invention, the AI bidding bot module 110 is implemented as an AI module 110 pre-trained using AI algorithm to perform a plurality of functions related to the auction. Upon communicating with the auction participants and encountering new events or incidents, the AI module 110 is continuously trained with the knowledge gained during the auction process, which helps in improving the performance of the system 200 which in turn enhances the efficiency of the auction process. The AI module 110, in rare instance, generates exceptions and those exceptions are handled by human agent. As the name specifies, the AI bidding bot module 110, in addition to communicating the bids, also bids in situations when the client or auction participant is absent for specific auction they have registered for. However, it should not be construed that it is only the AI bidding bot module 110 that bids during the auction process. The AI bidding bot module 110 is realized as a bid communicating medium while also being a bidding agent.

The sign-up module 202 collects and processes client requests. It captures essential information such as but not limited to, client details, preferred language for communication, auctions of interest, and the like. The sign-up module 202 also handles the initial authentication process that ensures only verified clients can access the bidding system. A RDBMS, such as PostgreSQL database 108, serves as a central data repository of the auction bidding system. The database 108 108 is structured to efficiently handle various aspects of the auction process, ensuring data integrity, quick retrieval, and secure storage. The database 108 maintains client profiles, including personal details, contact information, and authentication credentials. It stores client preferences such as preferred bidding language, notification settings, and default bidding limits. Each client is assigned a unique identifier that links to their historical bidding data and current auction participations.

In an exemplary embodiment, the database 108 stores detailed information about each auction, including auction dates, start times, end times, and associated lots. For each lot, it maintains descriptions, estimated values, starting bids, reserve prices, and current bid status. The database 108 is designed to handle multiple concurrent auctions. It further records each bid with a timestamp, the associated client, the bid amount, and the specific lot in real-time tracking which allows for instant updates to all connected clients. In one aspect, the database 108 is adapted to maintain bidding history for each client and each lot for both successful bids and unsuccessful attempts, which helps in detailed post-auction analysis.

In one aspect, the database 108 adapts PostgreSQL's ACID (Atomicity, Consistency, Isolation, Durability) properties to ensure transactional integrity. For instance, when multiple bids are placed simultaneously, the database 108 ensures that they are processed in the correct order without conflicts.

In further aspect, in order to handle the high volume of read and write operations during active auctions, the database 108 employs advanced indexing strategies. This includes creating appropriate indexes on frequently queried columns such as client IDs, auction IDs, and bid timestamps. Query optimization techniques are implemented to ensure rapid data retrieval even under heavy load.

In one embodiment, the AI bidding bot module 110 performs a plurality of functions associated with the auction process. The AI bidding bot module 110 initiates 218 phone calls to user devices of a plurality of clients to initiate the auction process. The phone call is initiated via a wireless telecommunications network. In an exemplary embodiment, the bot automatically calls registered clients at predetermined times, such as five minutes before the start of an auction. The AI bidding bot module 110 is also programmed to make multiple attempts 226 to reach the clients, via the phone call, if the initial communication is unsuccessful. In cases where voice communication is not possible, the bot can generate and transmit unique identification codes to clients, enabling them to place bids via text messages.

Upon successfully connecting with the user, via the phone call, the communication module 236 sends confirmation message to the user device. Further, the AI bidding bot module 110 presents 220 disclaimers and bid information to the clients to ensure clients are informed before participating by leveraging advanced natural language processing capabilities. The AI bidding bot module 110 interprets 222 voice prompts of the clients in multiple languages, and also records 224 the phone conversations. In an exemplary aspect, the bot module 110 is programmed understand and respond to voice prompts or commands in various languages, including Arabic, Japanese, Chinese Mandarin, Russian, German, French, and Spanish. For quality assurance and dispute resolution purposes, the bot records all interactions with clients.

In an exemplary aspect, the NLP engine 232 understands and interprets voice prompts from clients. The NLP engine 232 converts voice prompts into textual data and sends it to the AI bidding bot module 110. This NLP engine 232 processes commands in multiple languages, making the system accessible to global clients. Further, the AI bidding bot module 110 utilizes the communication module 236 to handle non-voice interactions with the clients, wherein the module 236 send text messages and emails, which can include auction reminders, bid confirmations, and unique identification codes for text-based bidding 234. In one aspect, the AI bidding bot module 110 is programmed to simultaneously send text messages and emails with the aforesaid information using the communication module 236. The communication module 236 ensures that clients remain informed about auction progress and their bidding status through multiple channels. In various aspects, the communication module 236 includes at least one of a messaging application and email services.

Once the auction process is initiated, the AI bidding bot module 110 presents bid amounts to the client and requests confirmation of the bidding amounts. The AI bidding bot module 110 requests the client to select either “yes” or “no” as voice prompt. In some aspects the AI bidding bot module 110 requests the client to select at least one numerical option via the dialpad of the communication module 236 in order to communicate the confirmation or rejection of bidding amount to the AI bidding bot module 110.

In one embodiment, when the client selects the bid confirmation option, for instance the confirmation option is “yes,” the NLP engine 232 converts the voice prompt into text data. The AI bidding bot module 110 receives the bid confirmation as text data from the NLP engine 232. The auction details, such as the bid confirmation and corresponding client details, are updated in the database 108 by the AI bidding bot module 110. An event communication module 236 monitors the database 108 for updated auction data and continuously communicates the updated auction data automatically to a central auction site 216. The clients participated in auction monitor the auction data via the central auction site 216 in real-time. In an embodiment, the event communication module 236 includes Webhook that updates the central auction site 216 when an event is triggered. The event includes confirmation or rejection of bids by the client that is updated in the database 108. In an exemplary aspect, the database 108 includes PostgreSQL database 108.

The system 200 utilizes Webhook for real-time data transfer for instantly registering and acknowledging the confirmed bids. The AI bidding bot module 110 is functional in tandem with the NLP engine 232 to process voice commands and transform them into formal bids to update in the database 108.

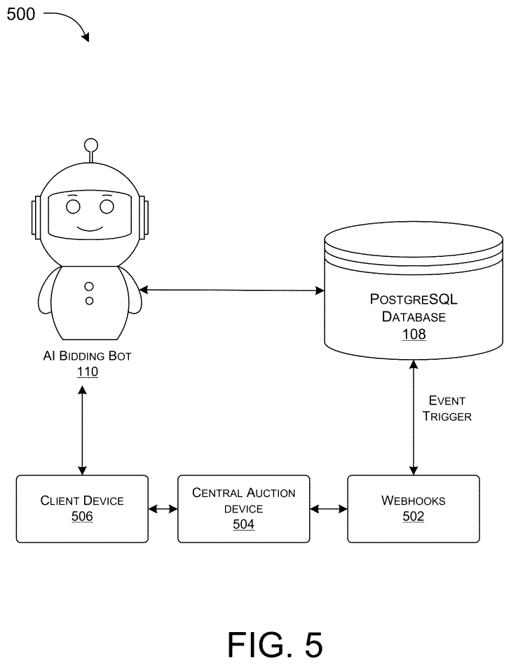

The process of transferring the bids to the central site is depicted in FIG. 5. The client communicates the bid via a user device 506 to an AI bidding bot module 110. The AI bidding bot module 110 receives the bid confirmation data from the NLP engine as text data. Then, the confirmed bid is updated in the database 108, wherein the database 108 is PostgreSQL database 108. As and when the bid details are updated in the database 108 corresponding to the client that confirmed the bid, the bide details along with the confirmed bid amount and client details are updated in a central auction site 504 by Webhook 502. Webhook 502 automatically updates aforesaid details in the central auction site 504 in real-time. Thus, the bid data can be monitored by the client in real-time via the central auction site 504.

The absentee bidding module 228 activates an absentee bidding protocol in cases where a client's connection is lost or they are unreachable via the phone call or other means of communication such as text or email. The protocol involves retrieving pre-set maximum bid amounts of absentee client from the PostgreSQL database 108 and incrementally placing 230 bids up to the maximum amount as competing bids are received. In one embodiment, during the sign-up process, the PostgreSQL database 108 stores the client's maximum bidding amounts for a specific auction they are participating in. The stored bid is retrieved when the client is absent for the absent or disconnected from the phone call during auction process.

In some aspects, the AI bidding module 110 continuously updates the bid status and auction progress in the central site. Clients receive audio notifications about competing bids and current auction status. The language validation module 204 verifies 206 the consistency of client responses in their chosen language, minimizing the risk of misunderstandings or errors. The bid verification module 212 ensures 214 that all bids are within the threshold, i.e. under the limit pre-set by client and adhere to auction rules, such that any accidental overbidding is prevented. If the bid verification module 212 identifies a bid that exceeding threshold, the bid amount may be ignored and the client is updated about the same.

In some aspects, the analytical module 208 tracks bidding patterns and analyzes client preferences, and the reporting module 210 generates post-auction summaries and performance metrics. The system includes a user-friendly dashboard interface that allows clients to view real-time auction status, check their bidding history, and update their preferences and maximum bid amounts.

The system described above can be implemented using various hardware and software configurations. The system may be constructed using specialized hardware designed for auction management, or it may utilize general-purpose computers configured with specific software to perform the required functions.

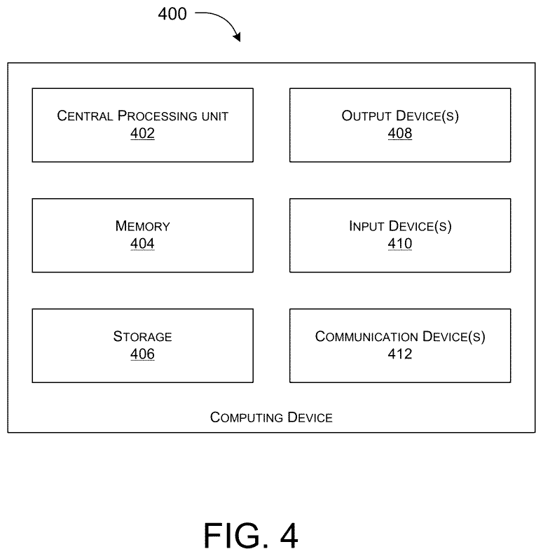

FIG. 4 illustrates a computing device 400 employed to implement various computing devices, computer processes, or software modules mentioned in the disclosure. The computing device 400 is utilized to process a plurality of calculations, execute instructions, and receive and transmit digital signals. Further the computing device 400 can handle search queries, process hypertext, and compile computer code as required by the system discussed above. The computing device 400 can be a distributed computing device with a plurality of components spread across multiple connected devices via network. Furthermore, it can function as a cloud-based computing device.

The computing device 400 is not restricted to any particular type of device. It can be any general or special-purpose computer that exists now or developed in the future, as long as it can perform the necessary steps and functions. These functions may be implemented through software, hardware, firmware, or a combination thereof.

The computing device 400 typically includes at least one central processing unit (CPU) or processor 402, and memory 404. The memory 404 can be volatile (like RAM), non-volatile (such as ROM or flash memory), or a combination of both. The device 400 may also incorporate one or more CPUs 402, allowing for parallel execution of processes. This flexibility in processing capabilities enables the described methods to be executed in multiple ways, including simultaneous processing by one or more CPUs 402.

The computing device 400 may be equipped with additional storage modules 406. This additional storage module 406 may include removable and non-removable media such as magnetic or optical disks or tape. The computer storage media includes volatile and non-volatile, removable and non-removable media for storing information such as computer readable instructions, data structures, program modules or other data. The computer storage media further includes but not limited to RAM, ROM, EEPROM, flash memory, CD-ROM, DVDs, magnetic cassettes, tapes, and disks. The computing device 400 comprises one or more communications devices 412 for enabling interaction with other devices. These communication devices include communication media, which typically embodies computer-readable instructions, data structures, program modules, or other data through modulated data signals. The communication media may include but not limited to wired media such as a wired network or direct-wired connection, and wireless media such as acoustic, RF, infrared and other wireless media. The computer-readable media includes computer storage media and communication media. The method of the invention disclosed herein may be encoded in any of aforesaid computer-readable media as data, computer-executable instructions, and the like.

The computing device 400 further includes input devices 410 such as keyboards, mice, pens, voice input devices, and touch input devices, and output devices 408 such as displays, speakers, printers, and other similar peripherals as known in the prior art.

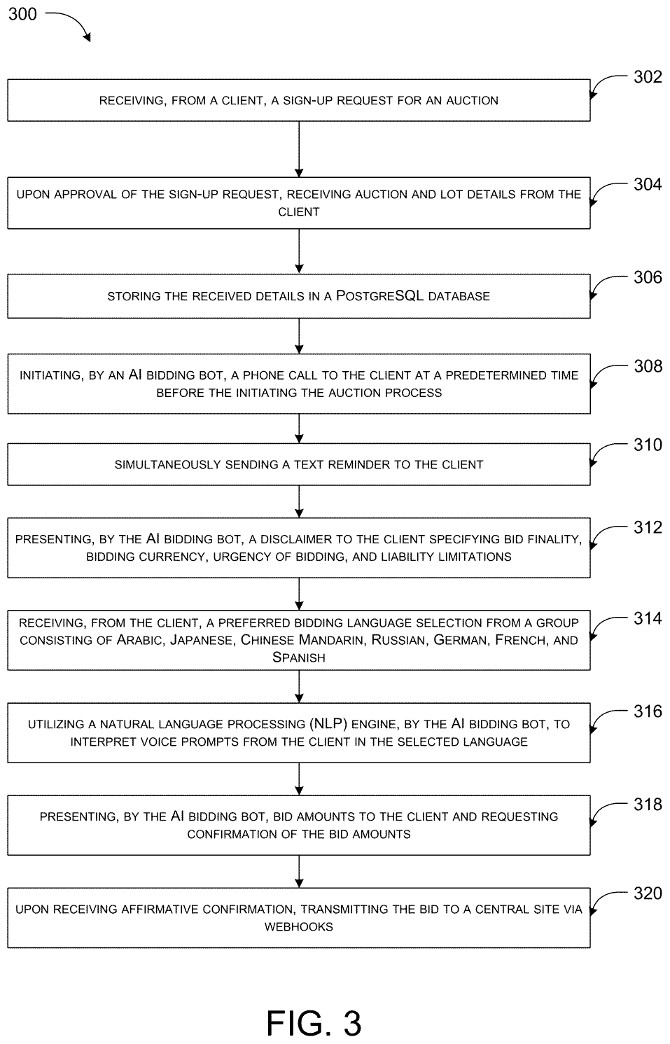

According to another exemplary embodiment, a method 300 for automated auction bidding is disclosed as shown in FIG. 3. The method 300 is implemented using the system 200 discussed above. At block 302, a sign-up request is received, from a client, for an auction. At 304, auction and lot details are received from the client upon approval of the sign-up request. At 306, the received details are stored in a PostgreSQL database. At 308, a phone call is initiated to a mobile device of the client by an AI bidding bot module, at a predetermined time before the initiating the auction process. At 310, a text reminder is simultaneously sent to the client.

In specific aspect, at least two additional calls are attempted, by the AI bidding bot module, to the client in the event of an unattended call. If the call is unattended by attempting multiple times, a unique identification code is sent to the mobile device of the client via text message or email for confirmation of client's participation in the auction. The client is allowed to confirm the identification code, for instance via text, so that AI bidding bot module allows the client to participate in text-based bids.

At 312, a disclaimer is presented, by the AI bidding bot module, to the client specifying bid finality, bidding currency, urgency of bidding, and liability limitations. At 314, a preferred bidding language is received from the client. The language is selected from a group consisting of Arabic, Japanese, Chinese Mandarin, Russian, German, French, and Spanish.

At 316, the AI bidding bot module interprets voice prompts from the client using a natural language processing (NLP) engine. At 318, the AI bidding bot module presents bid amounts to the client and requests confirmation of the bid amounts. In one aspect, requesting the confirmation includes requesting the client to select either yes or no as voice prompt. In some aspects the AI bidding bot module requests the client to select at least one numerical option via the dialpad of a communication module in order to communicate the confirmation or rejection of bidding amount to the AI bidding bot module. At 320, upon receiving affirmative confirmation, the confirmed bid amount is transmitted to a central site via webhooks.

In an exemplary embodiment, the AI bidding bot module receives the bid confirmation as text data from the NLP engine. The auction details, such as the bid confirmation and corresponding client details, are updated in the database by the AI bidding bot module. An event communication module monitors the database for updated auction data and continuously communicates the updated auction data automatically to a central auction site. The clients participated in auction monitor the auction data via the central auction site in real-time. In an embodiment, the event communication module includes Webhook that updates the central auction site when an event is triggered. The event includes confirmation or rejection of bids by the client that is updated in the database. In an exemplary aspect, the database includes PostgreSQL database.

In one specific aspect, the AI bidding bot module records the phone call for verification purposes. In another aspect, an absentee bid is automatically placed based on pre-established client parameters in case of call disconnection during auction process.

In another embodiment, the connection status of the phone call is continuously monitored and the absentee bidding protocol is immediately initiated upon detecting a disconnection. In a specific aspect, the absentee bidding protocol is activated in cases where a client's connection is lost or they are unreachable via the phone call or other means of communication such as text or email. The protocol involves retrieving pre-set maximum bid amounts of absentee client from the PostgreSQL database and incrementally placing bids up to the maximum amount as competing bids are received. In one embodiment, during the sign-up process, the PostgreSQL database stores the client's maximum bidding amounts for a specific auction they are participating in. The stored bid is retrieved when the client is absent for the absent or disconnected from the phone call during auction process.

In some aspects, the AI bidding module continuously updates the bid status and auction progress in the central site. Clients receive audio notifications about competing bids and current auction status. The method also includes verifying the consistency of client responses in their chosen language for minimizing the risk of misunderstandings or errors. As and when the bids confirmed by the clients, the bits are simultaneously verified if these are within the threshold, i.e. under the limit pre-set by client and adhere to auction rules, such that any accidental overbidding is prevented. If the AI bidding module identifies a bid that exceeding threshold, the bid amount may be ignored and the client is updated about the same.

This flexible approach to implementation allows the auction bidding system to be adapted to various scales of operation, from small auction houses to large, global auction platforms, while maintaining the core functionality described in the claims.

It will finally be understood that the disclosed embodiments are presently preferred examples of how to make and use the claimed invention, and are intended to be explanatory rather than limiting the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology. The scope of the invention supported by the above disclosure should accordingly be construed within the scope of what it teaches and suggests to those skilled in the art, and within the scope of any claims that the above disclosure supports. The scope of the invention is accordingly defined by the following claims.

This application is intended to cover any adaptations or variations of the present invention. Therefore, it is manifestly intended that this invention be limited only by the claims and the equivalents thereof.

1. A method for automated auction bidding, comprising:
receiving, from a plurality of auction participants, sign-up requests for an auction;
upon approval of the sign-up request, receiving auction and lot details from the auction participants;
storing the received details in a database;
initiating, by an AI bidding bot, phone calls to user devices of the auction participants, simultaneously, at a predetermined time before the initiating the auction process and simultaneously sending a text reminder to each auction participant;
presenting, by the AI bidding bot, a disclaimer to the auction participants by specifying bid finality, bidding currency, urgency of bidding, and liability limitations;
receiving, from the auction participants, preferred bidding language selection from a group consisting of Arabic, Japanese, Chinese Mandarin, Russian, German, French, and Spanish;
presenting, by the AI bidding bot, bid amounts to the auction participants and requesting confirmation of the bid amounts; and
receiving, by the AI bidding bot, the bid confirmation from one of the auction participants as a voice prompt, the voice prompt being the client preferred language;
sending the voice prompt to a natural language processing (NLP) engine and converting voice prompt to text data;
updating, by the AI bidding bot, the database with the confirmed bid; and
automatically transmitting the confirmed bid to a central site via Webhook.

2. The method of claim 1, wherein the requesting confirmation includes requesting the client to select either yes or no as voice prompt.

3. The method of claim 1, further comprising attempting at least two additional calls, by the AI bidding bot, to the auction participants in the event of an unattended call.

4. The method of claim 1, further comprising sending a unique identification code to the mobile device of the auction participants via text message or email, if the AI bidding bot is unable to establish voice-based communication.

5. The method of claim 1, further comprising accepting text-based bids, by the AI bidding bot, from the auction participants using the provided identification code.

6. The method of claim 1, further comprising:
continuously monitoring the connection status of the phone call; and
automatically initiating the absentee bidding protocol upon detecting a disconnection of call.

7. The method of claim 6, wherein automatically initiating the absentee bidding protocol includes placing an absentee bid based on a pre-set threshold.

8. The method of claim 7, wherein pre-set threshold includes a maximum bid amount set by the auction participant during sign-up step.

9. The method of claim 1, wherein the database includes PostgreSQL database.

10. A system comprising a processor and memory, wherein the processor and the memory in
combination are operable to implement a method comprising:
receiving, from a plurality of auction participants, sign-up requests for an auction;
upon approval of the sign-up request, receiving auction and lot details from the auction participants;
storing the received details in a database;
initiating, by an AI bidding bot, phone calls to user devices of the auction participants, simultaneously, at a predetermined time before the initiating the auction process and simultaneously sending a text reminder to each auction participant;
presenting, by the AI bidding bot, a disclaimer to the auction participants by specifying bid finality, bidding currency, urgency of bidding, and liability limitations;
receiving, from the auction participants, preferred bidding language selection from a group consisting of Arabic, Japanese, Chinese Mandarin, Russian, German, French, and Spanish;
presenting, by the AI bidding bot, bid amounts to the auction participants and requesting confirmation of the bid amounts; and
receiving, by the AI bidding bot, the bid confirmation from one of the auction participants as a voice prompt, the voice prompt being the client preferred language;
sending the voice prompt to a natural language processing (NLP) engine and converting voice prompt to text data;
updating, by the AI bidding bot, the database with the confirmed bid; and
automatically transmitting the confirmed bid to a central site via Webhook.

11. The system of claim 10, wherein the requesting confirmation includes requesting the auction participant to select either yes or no as voice prompt.

12. The system of claim 10, further comprising attempting at least two additional calls, by the AI bidding bot, to the auction participant in the event of an unattended call.

13. The system of claim 10, further comprising sending a unique identification code to the mobile device of the auction participant via text message or email, if the AI bidding bot is unable to establish voice-based communication.

14. The system of claim 10, further comprising accepting text-based bids, by the AI bidding bot, from the auction participant using the provided identification code.

15. The system of claim 10, further comprising:
continuously monitoring the connection status of the phone call; and
automatically initiating the absentee bidding protocol upon detecting a disconnection of call.

16. The system of claim 15, wherein automatically initiating the absentee bidding protocol includes placing an absentee bid based on a pre-set threshold.

17. The system of claim 16, wherein pre-set threshold includes a maximum bid amount set by the auction participant during sign-up step.

18. The system of claim 10, wherein the database includes PostgreSQL database.

19. A non-transitory computer-readable medium storing instructions that, when executed by
a processor, cause the processor to perform a method comprising:
receiving, from a plurality of auction participants, sign-up requests for an auction;
upon approval of the sign-up request, receiving auction and lot details from the auction participants;
storing the received details in a database;
initiating, by an AI bidding bot, phone calls to user devices of the auction participants, simultaneously, at a predetermined time before the initiating the auction process and simultaneously sending a text reminder to each auction participant;
presenting, by the AI bidding bot, a disclaimer to the auction participants by specifying bid finality, bidding currency, urgency of bidding, and liability limitations;
receiving, from the auction participants, preferred bidding language selection from a group consisting of Arabic, Japanese, Chinese Mandarin, Russian, German, French, and Spanish;
presenting, by the AI bidding bot, bid amounts to the auction participants and requesting confirmation of the bid amounts; and
receiving, by the AI bidding bot, the bid confirmation from one of the auction participants as a voice prompt, the voice prompt being the client preferred language;
sending the voice prompt to a natural language processing (NLP) engine and converting voice prompt to text data;
updating, by the AI bidding bot, the database with the confirmed bid; and
automatically transmitting the confirmed bid to a central site via Webhook.
